(19) United States
(12) Patent Application Publication
(10) Pub. No.: US 2021/0328227 A1
(43) Pub. Date: Oct. 21, 2021

(54) ELECTRODE TERMINAL HAVING HIGH CORROSION RESISTANCE FOR SECONDARY BATTERY AND METHOD FOR MANUFACTURING THE SAME

(71) Applicant: TPS, Inc, Ansan-si (KR)

(72) Inventor: Seungsoo Kim, Seoul (KR)

(21) Appl. No.: 16/850,808

(22) Filed: Apr. 16, 2020

(51) Int. Cl. H01M 4/66; H01M 4/04

(52) U.S. Cl. CPC H01M 4/661; H01M 4/0438; H01M 4/0404

(57) ABSTRACT

An electrode terminal having high corrosion resistance for a secondary battery includes, a base layer which is made of a conductive material, and a first coating layer which is formed on a surface of the base layer, wherein the first coating layer has a higher corrosion resistance than the base layer, the first coating layer is formed by electroplating, the first coating layer is made of a material containing a metal material and a non-metal material, and the non-metal material of the first coating layer is contained in a smaller amount than the metal material.

### STATEMENT REGARDING PRIOR DISCLOSURE

The Korean Patent Application No. 10-2008-0135073 on which this application is based was disclosed in the Korean Patent No. 10-1976084, issued on Apr. 30, 2019, which is a grace period disclosure exception under 35 U.S.C. 102(b)(1)(A).

### TECHNICAL FIELD

The present disclosure relates to an electrode terminal having high corrosion resistance for a secondary battery and a method for manufacturing the same.

### BACKGROUND ART

The secondary battery industry is in the spotlight as a core component of IT devices in addition to semiconductors and displays. In recent years, the use of the secondary battery is being increased for applications such as electric bicycles, hybrid vehicles (HEV), electric vehicles (EV), plug-in hybrid vehicles (PHEV), and energy storage devices (ESS), which use large-capacity batteries.

Electrode terminals (anode terminal and cathode terminal), which are one of the components of a typical secondary battery, contact or are connected to the ends (that is, electrode tab) of a current collector to electrically connect the current collector to the outside. One side of the electrode terminal is positioned inside a unit cell case of the secondary battery, the other side thereof is positioned outside the unit cell case, and an insulating film is attached to the middle of the electrode terminal to prevent electrolyte solution inside the unit cell from leaking through the junction between the electrode terminal and the case.

Such an electrode terminal usually uses the same material as the current collector, and is plated with a corrosion resistance metal to prevent corrosion by external air and foreign substances. Specifically, the anode terminal and the anode current collector may be made of an aluminum material, and the cathode terminal and cathode current collector may be made of a copper material, and the electrode terminal made of an aluminum or copper material is oxidized well and is vulnerable to corrosion, such that the electrode terminal is used by plating nickel or the like on the surface thereof.

### RELATED ART DOCUMENTS

(Patent Document 1) Korean Patent No. 10-1698564 (Jan. 23, 2017)

### DETAILED DESCRIPTION OF THE INVENTION

### Technical Problem

The present disclosure provides an electrode terminal having high corrosion resistance for a secondary battery having excellent corrosion resistance.

### Technical Solution

An aspect of the present disclosure provides an electrode terminal having high corrosion resistance for a secondary battery, the electrode terminal being configured to be bonded to an electrode current collector of the secondary battery, the electrode terminal including a base layer which is made of a conductive material, and a first coating layer which is formed on a surface of the base layer, wherein the first coating layer has a higher corrosion resistance than the base layer, the first coating layer is formed by electroplating, the first coating layer is made of a material comprising a metal material and a non-metal material, and the non-metal material of the first coating layer is contained in a smaller amount than the metal material.

The electrode terminal having high corrosion resistance for the secondary battery may further include a second coating layer which is formed on a surface of the first coating layer.

The electrode terminal having high corrosion resistance for the secondary battery may further include a chromate layer which is formed on a surface of the second coating layer, and an adhesive force of the chromate layer to the second coating layer may be larger than an adhesive force of the chromate layer to the first coating layer.

The second coating layer may be formed by electroplating, and the second coating layer may be made of a material comprising the same metal material as the metal material contained in the first coating layer.

The base layer may be made of a material comprising copper (Cu), the first coating layer may be made of a material comprising nickel (Ni) and phosphorous (P), the phosphorous (P) of the first coating layer may be contained in an amount of 12 to 18% by weight, and the second coating layer may be made of a material containing nickel (Ni).

Another aspect of the present disclosure provides a method for manufacturing an electrode terminal having high corrosion resistance for a secondary battery, the electrode terminal being configured to be bonded to an electrode current collector of the secondary battery, the method including forming a first coating layer on a surface of a conductive base layer, wherein the first coating layer has a higher corrosion resistance than the base layer, the first coating layer is formed by electroplating, the first coating layer is made of a material containing a metal material and a non-metal material, and the non-metal material of the first coating layer is contained in a smaller amount than the metal material.

The method for manufacturing the electrode terminal having high corrosion resistance for the secondary battery may further include forming a second coating layer on surface of the first coating layer, after the forming of the first coating layer.

The method for manufacturing the electrode terminal having high corrosion resistance for the secondary battery may further include forming a chromate layer on surface of the second coating layer, after the forming of the second coating layer, and an adhesive force of the chromate layer to the second coating layer may be larger than an adhesive force of the chromate layer to the first coating layer.

The second coating layer may be formed by electroplating, and the second coating layer may be made of a material comprising the same metal material as the metal material contained in the first coating layer.

The base layer may be made of a material comprising copper (Cu), the first coating layer may be made of a material comprising nickel (Ni) and phosphorous (P), phosphorous (P) in plating solution for the electroplating of the first coating layer may be contained in an amount of 6 to 7% by weight, and the second coating layer may be made of a material comprising nickel (Ni).

### Advantegeous Effecs

The present disclosure may provide the electrode terminal having high corrosion resistance for the secondary battery having excellent corrosion resistance.

### BRIEF DESCRIPTION OF THE DRAWINGS

FIG. 1 is a diagram illustrating a state where an electrode terminal having high corrosion resistance according to an embodiment of the present disclosure is coupled to a secondary battery.

FIG. 2 is a plan diagram illustrating the electrode terminal having high corrosion resistance for the secondary battery according to an embodiment of the present disclosure.

FIG. 3 is a cross-sectional diagram illustrating the electrode terminal having high corrosion resistance for the secondary battery according to an embodiment of the present disclosure.

FIG. 4 is a diagram illustrating a plating process for manufacturing the electrode terminal having high corrosion resistance for the secondary battery according to an embodiment of the present disclosure.

FIG. 5 shows photographs illustrating the cross section of the electrode terminal having high corrosion resistance for the secondary battery according to an embodiment of the present disclosure.

FIGS. 6(a) and 6(b) show photographs comparing cross sections of the electrode terminal having high corrosion resistance for the secondary battery according to an embodiment of the present disclosure and an electrode terminal according to a Comparative Example.

FIG. 7 shows comparative experimental photographs illustrating the corrosion resistance test results of the electrode terminal having high corrosion resistance for the secondary battery according to an embodiment of the present disclosure and the electrode terminal according to the Comparative Example.

### BEST MODE

Various changes and various embodiments may be made in the present disclosure, such that specific embodiments are illustrated in the drawings and described in detail in the detailed description. It should be understood, however, that it is not intended to limit the present disclosure to the particular disclosed forms, but includes all modifications, equivalents, and alternatives falling within the sprit and technical scope of the present disclosure. In describing the present disclosure, when it is determined that specific descriptions for the related known technology obscure the subject matter of the present disclosure, detailed descriptions thereof will be omitted.

Terms such as first and second may be used to describe various components, but the components should not be limited by the terms. The terms are used merely for the purpose of distinguishing one component from other components.

The terminology used in the present application is merely for the purpose of describing particular embodiments, and is not intended to limit the present disclosure. The singular expression includes plural expression, unless the phrases clearly indicate the opposite. In the present application, it should be understood that the term “comprising”, “having”, or the like specifies the presence of the characteristic, integer, step, operation, component, part, or a combination thereof described in the specification, and does not exclude the presence or addition possibility of one or more other characteristics, integers, steps, operations, components, parts or combinations thereof in advance.

Hereinafter, an embodiment of an electrode terminal having high corrosion resistance for a secondary battery according to the present disclosure and a method for manufacturing the same will be described in detail with reference to the accompanying drawings, and in describing with reference to the accompanying drawings, the same reference numerals are denoted by the same or corresponding components and redundant descriptions thereof will be omitted.

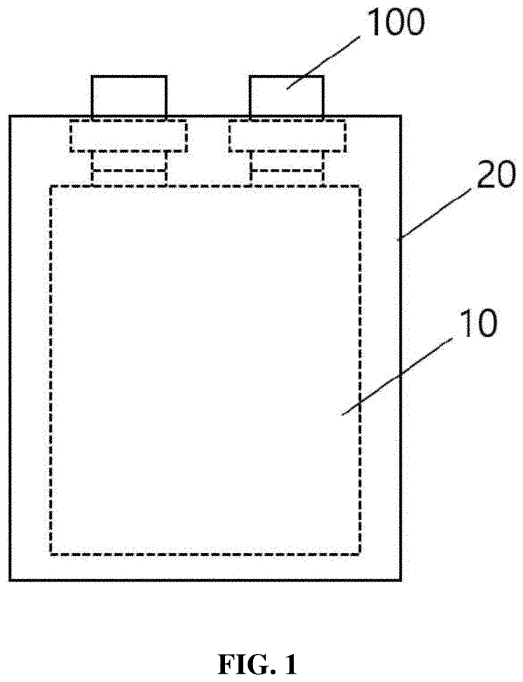

According to the present embodiment, as illustrated in FIGS. 1 to 3, as an electrode terminal 100 bonded to an electrode current collector 10 of a secondary battery, proposed is the electrode terminal 100 having high corrosion resistance including a base layer 110, a first coating layer 120, a second coating layer 130, a chromate layer 140, and an insulating strip 150.

According to the present embodiment as described above, the first coating layer 120 having excellent corrosion resistance may significantly improve the corrosion resistance of the electrode terminal 100, and at the same time, the second coating layer 130 may increase the adhesive property of the chromate layer 140 to eventually increase the adhesive property of the insulating strip 150, thereby further improving the sealing property at the junction between a secondary battery case 20 and the electrode terminal 100.

As illustrated in FIG. 1, the secondary battery may be composed of a case 20, an electrode disposed inside the case 20, the electrode current collector 10 electrically connected to the electrode, and the electrolyte solution charged in an inner space of the case 20, and these ends (electrode tabs) of the electrode current collector 10 may have the electrode terminal 100 bonded for electrical connection with external devices, respectively.

The electrode terminal 100 may be bonded to the end of the electrode current collector 10 by a method such as welding, and it is also necessary to importantly consider weldability when the surface of the electrode terminal 100 is treated. The present embodiment may form the second coating layer 130 in a crystalline structure by an electroplating method and also form the thickness of the second coating layer 130 relatively, thinly as compared to the first coating layer 120, thereby enhancing weldability to the ends of the electrode current collector 10.

The case 20 of the secondary battery may be composed of, for example, a laminate film in which a metal foil is laminated on at least one surface of a resin film. The metal foil may be made of nickel, copper, aluminum, stainless, or the like which does not permeate water. As the resin film, a thermally-bonding film such as nylon, polyethylene, polypropylene, or polyethylene terephthalate may be used.

The case 20 of the secondary battery may be sealed by accommodating inside the electrode, the electrode current collector 10, and the electrolyte solution, which are described above, between a pair of laminate films therein and then thermally bonding the edge. In this case, a part of the electrode terminal 100 may be accommodated inside the case 20 and the remainder may be exposed outside the case 20, and the insulating strip 150 bonded to the central region of the electrode terminal 100 may be thermally bonded and bonded to the edges of the case 20 together with the case 20, thereby preventing the electrolyte solution inside the case 20 from leaking outward.

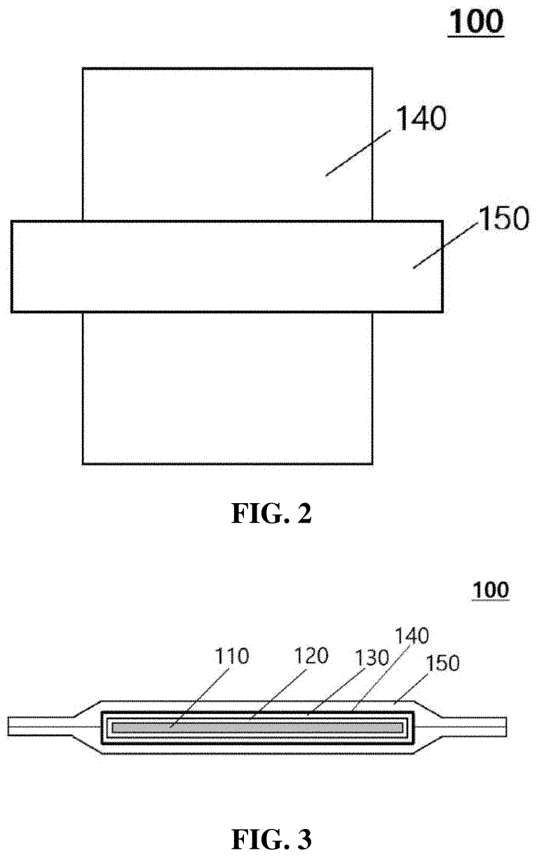

As illustrated in FIGS. 2 and 3, the electrode terminal 100 may be composed of the base layer 110, the first coating layer 120, the second coating layer 130, the chromate layer 140, and the insulating strip 150.

The base layer 110 may be made of a conductive material. The base layer 110 of the electrode terminal 100 may be made of different materials depending on whether the electrode is an anode or a cathode. The anode electrode terminal 100 may be made of an aluminum material, and the cathode electrode terminal 100 may be made of a copper (Cu) material. The present embodiment proposes the cathode electrode terminal 100 as an example.

The first coating layer 120 may be formed on the surface of the base layer 110, and made of a material having a higher corrosion resistance than the base layer 110. In this case, the first coating layer 120 may be made of a material containing all of a metal material and a non-metal material, and the non-metal material of the first coating layer 120 may be an additive contained in a smaller amount than the metal material.

As described above, by forming the first coating layer 120 of a corrosion resistance material, it is possible to prevent corrosion of the electrode terminal 100 due to external air, foreign substances, or the like more effectively.

The first coating layer 120 may be, for example, made of a corrosion resistance material such as a nickel alloy containing nickel (Ni) and other additives, and more specifically, the first coating layer 120 may be made of a nickel-phosphorus alloy containing nickel (Ni) and phosphorus (P). Further, phosphorus (P) in the first coating layer 120 may be contained in an amount of 12 to 18% by weight.

If the content of phosphorus (P) in the first coating layer is less than 12% by weight, the corrosion resistance (electrolytic resistance) of the product may be lowered, and if the content of phosphorus (P) exceeds 18% by weight, the plating speed may be lowered, thereby deteriorating productivity.

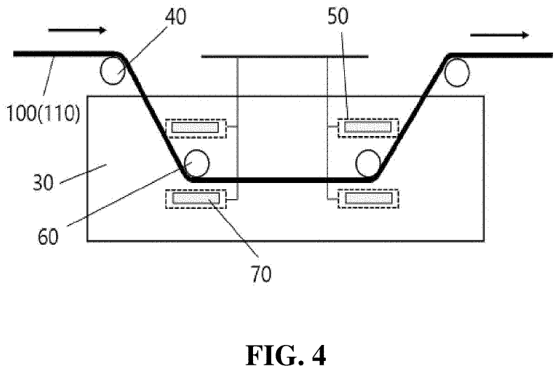

Further, as described above, the first coating layer 120, which is a nickel-phosphorus alloy, may be formed by an electroplating method as illustrated in FIG. 4. In this case, the first coating layer 120 may be formed by electroplating for a total of 2 minutes over two times.

Further, prior to such an electroplating process, water washing (washing)—degreasing (removing foreign substances and oil)—water washing (washing)—etching (surface roughness formation, adhesive force improvement)—water body (washing) process may be performed as pre-treatment.

As illustrated in FIG. 4, a mesh-typed basket is disposed within a plating tank 30 containing plating solution as the anode 50, and a nickel crown may be accommodated within such a basket as a plating material 70. Further, a roller 60 is disposed inside and outside the plating tank 30 so that the electrode terminal 100 (base layer 110) for plating is transferred by the roller 60 and the plating process may be continuously performed. Further, any one of the rollers 60, for example, the roller 60 outside the plating tank 30 may be used as a cathode 40 of the plating process to apply negative electricity to the electrode terminal 100 (base layer 110) contacting the roller 60.

In this case, the plating solution for electroplating of the first coating layer 120 may include boric acid, nickel sulfate, and nickel chloride, and additionally include NOVOPLATE HS REPLENISHER (Novoplate-HS) containing phosphorus.

These boric acid, nickel sulfate, nickel chloride, and Novoplate-HS may be mixed at, for example, 6 parts by weight, 45 parts by weight, 6 parts by weight, and 7.14 parts by weight, respectively, with respect to water 100 parts by weight. Phosphorus (P) in the thus mixed plating solution may be contained in an amount of 6 to 7% by weight.

If the content of phosphorus in the plating solution is lower than 6% by weight, there is a problem in the quality of the electrode terminals 100 due to poor corrosion resistance, and conversely, if the content of phosphorus in the plating solution is higher than 7% by weight, the plating speed is slower, thereby being disadvantageous in productivity.

Chemical reaction according to the electroplating of the first coating layer 120 may be represented as follows.

[Basic Reaction]

NiSO₄↔Ni²⁺+SO4²⁻

NiCl₂↔Ni²⁺+2Cl⁻

H₃BO₃↔3H⁺+BO₃³⁻

Hydrogen generation: H₂PO₂⁻+H₂O→H₂PO₃⁻+H₂

Nickel precipitation: Ni²⁺+H₂PO₂⁰+H₂O→(Cat)→Ni⁰+H₂PO₃⁻+2H⁺

Phosphorous precipitation: H₂PO₂⁻+H⁺→P+OH+H₂O

[Cathode 40]

Ni²⁺+2e⁻>Ni (plating precipitation)

2H⁺+2e⁻→H₂ (hydrogen gas)

[Anode 50]

Ni→Ni²⁺+2e⁻ (generation of nickel ions in the nickel anode 50)

H₂O→2H⁺+½O₂+2e⁻ (oxygen gas)

Ni+2Cl⁻→NiCl₂+2e⁻↔Ni2++2Cl⁻ (the nickel anode 50 reacts with chlorine ions dissociated from nickel chloride to promote the generation of nickel ions)

As described above, in the present embodiment, by adding phosphorus to the plating solution to form the first coating layer 120 containing phosphorus in nickel upon electroplating, it is possible to significantly improve the corrosion resistance of the electrode terminal 100.

When a coating layer made of only nickel is formed by performing electroplating with the plating solution containing no phosphorus, there are disadvantages in that a plating layer having a porous structure may be formed, thereby being easily corroded to the inside of the plating layer, and the thickness of the plating layer is thickened to lower thermal conductivity, thereby having poor weldability, and when the coating layer is formed by an electroless plating method by using the chemical plating solution containing nickel and phosphorus, there are disadvantages in that the plating layer is formed in an amorphous structure to lower the adhesive force with the chromate layer 140, such that numerous processes are required to be repeated for forming the chromate layer 140, the plating speed is slower due to the dependence on chemical reaction, thereby lowering the productivity, and particles have high density due to the amorphous structure, thereby having poor weldability.

Accordingly, in the present embodiment, by forming the first coating layer 120 containing the nickel-phosphorus component in an electroplating method by containing the phosphorus component in the electroplating solution for nickel plating, it is possible to improve the corrosion resistance by the phosphorus component, and to improve the adhesive force with the chromate layer 140 due to the porous structure, thereby also improving the adhesive force with the insulating strip 150, improving the productivity according to the electroplating, and obtaining good weldability by forming the plating thickness thinly in a crystalline type.

Subsequently, the second coating layer 130 may be formed on the surface of the first coating layer 120, and made of a material having a higher corrosion resistance than the base layer 110 like the first coating layer 120, but the second coating layer 130 may be made of a material having a lower corrosion resistance than the first coating layer 120. In this case, the second coating layer 130 may be made of a material containing the same metal material as the metal material contained in the first coating layer 120. More specifically, the second coating layer 130 may be made of a material containing nickel without phosphorus.

As described above, by forming the second coating layer 130 having corrosion resistance likewise on the first coating layer 120 having corrosion resistance to implement a double corrosion resistance structure, it is possible to further improve the corrosion resistance of the electrode terminal 100.

Further, the chromate layer 140 may be formed on the surface of the second coating layer 130, and the adhesive force to the second coating layer 130 of the chromate layer 140 may be larger than the adhesive force to the first coating layer 120. That is, the second coating layer 130 may be formed by electroplating to have a porous structure, and by forming the second coating layer 130 on the surface of the first coating layer 120, it is possible to further improve the adhesive force with the chromate layer 140, thereby adhering and firmly bonding the insulating strip 150 to the electrode terminal 100 by the chromate layer 140.

The first coating layer 120 is also formed in a porous structure, which is advantageous in adhesion with the chromate layer 140 but the second coating layer 130 may be formed in a more uniform crystalline structure because it does not contain phosphorus, such that the second coating layer 130 may be more advantageous in terms of the adhesion with the chromate layer 140 than the first coating layer 120.

Meanwhile, the second coating layer 130 may be formed to have a thickness thinner than the first coating layer 120. The plating thickness may be controlled by controlling an electroplating time, and the second coating layer 130 may be formed through electroplating for about half the time as compared to the first coating layer 120 to have a thickness of about half of the first coating layer 120. The first coating layer 120 and the second coating layer 130 may have a total thickness of 0.6 to 1.4 micrometers.

As described above, the second coating layer 130 is formed by electroplating and has a crystalline structure and may also be formed to have a thickness thinner than the first coating layer 120 by controlling the plating time, thereby further increasing weldability to the end of the electrode current collector 10.

The second coating layer 130 made of nickel may be formed by an electroplating method as shown in FIG. 4 like the first coating layer 120. The second coating layer 130 may be formed by electroplating for about 1 minute.

Further, prior to the present process, a water washing (washing) process is performed, and after the present process, a chromate treatment (giving the adhesive force to the insulating strip 150)—water washing (washing)—drying process may be performed. The entire process from the aforementioned pre-treatment process of the first coating layer 120 to the drying process may be continuously performed in a reel to reel process.

The plating solution for electroplating of the second coating layer 130 is the same as the plating solution for forming the first coating layer 120 except for NOVOPLATE HS

REPLENISHER (Novoplate-HS) containing phosphorus, but boric acid, nickel sulfate, and nickel chloride, for example, may be mixed at 4 parts by weight, 13.33 parts by weight, and 4 parts by weight, respectively, with respect to water 100 parts by weight.

The chromate layer 140 on the surface of the second coating layer 130 is configured to increase the adhesive force with the insulating strip 150 and may be formed to have a thickness of about 1.5 to 5 nanometers through the aforementioned chromate surface treatment. The chromate surface treatment may be performed by immersing the electrode terminal 100 formed up to the second coating layer 130 in the chromate solution.

As illustrated in FIGS. 2 and 3, the insulating strip 150 may be formed to cover a partial region (central region) of the chromate layer 140 to be bonded to the case 20 of the secondary battery. As described above, the chromate layer 140 is formed as the surface treatment to improve the adhesive force with the insulating strip 150, and the chromate layer 140 may be better adhered to the second coating layer 130 than the first coating layer 120.

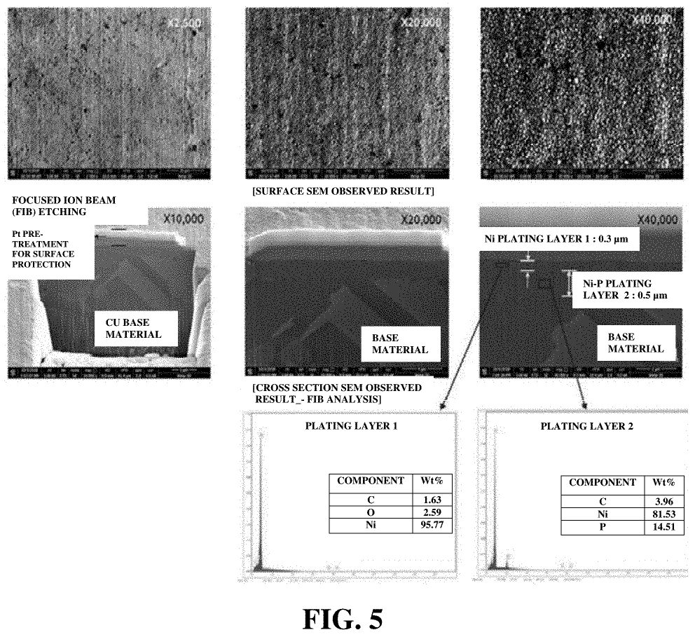

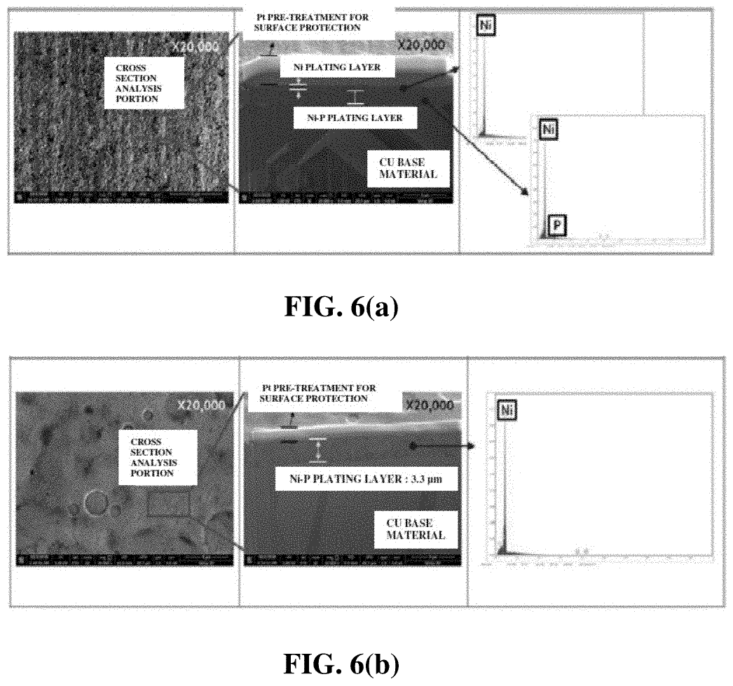

FIGS. 5 and 6 show photographs illustrating cross sections of the electrode terminal 100 having high corrosion resistance for the secondary battery according to an embodiment of the present disclosure and the electrode terminal 100 according to a Comparative Example.

As illustrated in FIGS. 5 and 6, the electrode terminal 100 according to the present embodiment may be composed of the first coating layer 120 made of a nickel-phosphorus alloy on the base layer 110 made of copper, and the second coating layer 130 made of nickel (FIGS. 5 and 6(a)), thereby significantly improving the corrosion resistance as compared to the terminal (FIG. 6(b)) having the coating layer made of only nickel, of course, largely improving the adhesive property with the chromate layer 140, furthermore, the insulating strip 150 as well, and largely improving weldability with the end of the electrode current collector 10 as well.

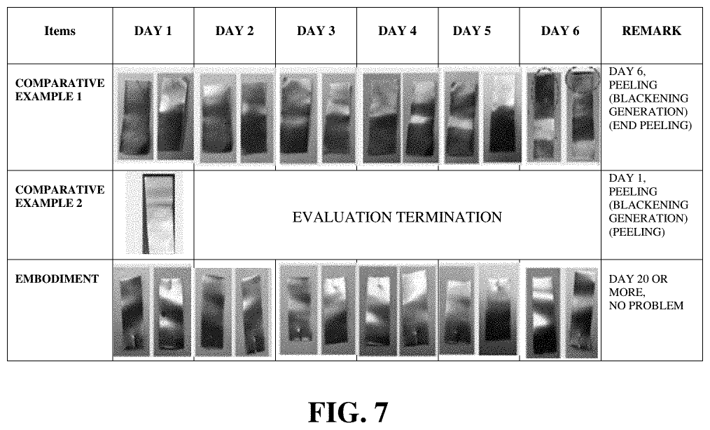

FIG. 7 shows comparative experimental photographs illustrating the corrosion resistance test results of the electrode terminal 100 having high corrosion resistance for the secondary battery according to an embodiment of the present disclosure and the electrode terminal 100 according to the Comparative Example.

This corrosion resistance test was conducted at 85 degrees Celsius by using the following electrolyte solution (10,000 ppm).

[Electrolyte Solution]
Manufacturer: enchem
Model name: GE01
Main components: Cyclic carbonate contents<30%
   Linear carbonate contents<70%
   Li-salt<20%
   Additive<5%

Comparative Example 1 is a terminal which forms a nickel-phosphorus plating layer containing 6% by weight of phosphorus in a thickness of 0.7 micrometers in an electroless plating method, and Comparative Example 2 is a terminal which forms a nickel plating layer containing no phosphorus in an electroplating method.

Further, an embodiment illustrated in FIG. 7 is the same embodiment as illustrated in FIG. 5, and is the electrode terminal 100 which forms the nickel-phosphorus plating layer containing 14.51% by weight of phosphorus in a thickness of 0.5 micrometers in an electroplating method and forms the nickel plating layer thereon in a thickness of 0.3 micrometers.

In the Comparative Example 1, peeling occurred in only 6 days, and in the Comparative Example 2, peeling occurred in only 1 day whereas in the present embodiment, corrosion did not occur within the electrolyte solution for a period of 20 days or more, such that it may be confirmed that the electrode terminal 100 is superior to products of other structures/methods in terms of the corrosion resistance.

As described above, while the embodiments of the present disclosure have been described, those skilled in the art may variously modify and change the present disclosure by the addition, change, deletion or the like of the component without departing from the spirit of the present disclosure as set forth in the claims, and the above is also included within the claims of the present disclosure.

What is claimed is:

1. An electrode terminal having high corrosion resistance for a secondary battery, the electrode terminal being configured to be bonded to an electrode current collector of the secondary battery, the electrode terminal comprising:
a base layer which is made of a conductive material; and
a first coating layer which is formed on a surface of the base layer,
wherein the first coating layer has a higher corrosion resistance than the base layer,
wherein the first coating layer is formed by electroplating,
wherein the first coating layer is made of a material comprising a metal material and a non-metal material, and
wherein the non-metal material of the first coating layer is comprised in a smaller amount than the metal material.

2. The electrode terminal of claim 1, further comprising a second coating layer which is formed on a surface of the first coating layer.

3. The electrode terminal of claim 2, further comprising a chromate layer which is formed on a surface of the second coating layer,
wherein an adhesive force of the chromate layer to the second coating layer is larger than an adhesive force of the chromate layer to the first coating layer.

4. The electrode terminal of claim 3,
wherein the second coating layer is formed by electroplating, and
wherein the second coating layer is made of a material comprising the same metal material as the metal material comprised in the first coating layer.

5. The electrode terminal having high corrosion resistance for the secondary battery of claim 4,
wherein the base layer is made of a material comprising copper (Cu),
wherein the first coating layer is made of a material comprising nickel (Ni) and phosphorous (P),
wherein the phosphorous (P) of the first coating layer is comprised in an amount of 12 to 18% by weight, and
wherein the second coating layer is made of a material comprising nickel (Ni).

6. A method for manufacturing an electrode terminal having high corrosion resistance for a secondary battery, the electrode terminal being configured to be bonded to an electrode current collector of the secondary battery, the method comprising,
forming a first coating layer on a surface of a conductive base layer,
wherein the first coating layer has a higher corrosion resistance than the base layer,
wherein the first coating layer is formed by electroplating,
wherein the first coating layer is made of a material comprising a metal material and a non-metal material, and
wherein the non-metal material of the first coating layer is comprised in a smaller amount than the metal material.

7. The method of claim 6, further comprising forming a second coating layer on a surface of the first coating layer, after the forming of the first coating layer.

8. The method of claim 7, further comprising forming a chromate layer on a surface of the second coating layer, after the forming of the second coating layer,
wherein an adhesive force of the chromate layer to the second coating layer is larger than an adhesive force of the chromate layer to the first coating layer.

9. The method of claim 8,
wherein the second coating layer is formed by electroplating, and
wherein the second coating layer is made of a material comprising the same metal material as the metal material comprised in the first coating layer.

10. The method of claim 9,
wherein the base layer is made of a material comprising copper (Cu),
wherein the first coating layer is made of a material comprising nickel (Ni) and phosphorous (P),
wherein phosphorous (P) in plating solution for the electroplating of the first coating layer is comprised in an amount of 6 to 7% by weight, and
wherein the second coating layer is made of a material comprising nickel (Ni).
